(19) United States
(12) Patent Application Publication
(10) Pub. No.: US 2026/0152983 A1
(43) Pub. Date: Jun. 4, 2026

(54) SLIDING DOOR SUPPORT STRUCTURE

(71) Applicant: AISIN CORPORATION, Kariya (JP)

(72) Inventors: Yuta FUKAMI, Kariya-shi (JP); Masato MORI, Kariya-shi (JP); Eisuke SATO, Kariya-shi (JP)

(73) Assignee: AISIN CORPORATION, Kariya (JP)

(21) Appl. No.: 19/381,429

(22) Filed: Nov. 6, 2025

(30) Foreign Application Priority Data
Dec. 2, 2024 (JP) 2024-209419

(51) Int. Cl. E05D 15/10

(52) U.S. Cl. CPC E05D 15/1047; E05D 2015/1057; E05Y 2201/688; E05Y 2900/531

(57) ABSTRACT

Disclosed is a sliding door support structure including: a first slide support mechanism including a first slide rail either above a door opening or below the door opening in a vehicle body and regulating a path of the door while supporting the door; and a second slide support mechanism including a second slide rail and a third slide rail that are provided below the upper end and of the door opening and above the lower end of the door opening and regulating the path of the door, in which the second slide rail and the third slide rail are disposed apart from each other in the vertical direction, and the second slide support mechanism regulates the path of the door while receiving a weight of the door and receives force acting in the tilting direction of the door through the second slide rail and the third slide rail.

### CROSS REFERENCE TO RELATED APPLICATIONS

This application is based on and claims priority under 35 U.S.C. § 119 to Japanese Patent Application 2024-209419, filed on December 2, 2024, the entire content of which is incorporated herein by reference.

### TECHNICAL FIELD

This disclosure generally relates to a sliding door support structure.

### BACKGROUND DISCUSSION

With regard to a sliding door support structure slidably supporting a vehicle door covering a vehicle body opening in a closed state, a known technique for disposing a slide rail (also referred to as an “upper slide rail”) above an upper end of the vehicle body opening in the vehicle, disposing a slide rail (also referred to as a “lower slide rail”) below a lower end of the vehicle body opening, and disposing a slide rail (also referred to as a “middle slide rail”) behind the vehicle body opening is disclosed in, for example, JP2020-79513A.

However, since the upper slide rail linearly extending in a longitudinal direction of the vehicle is disposed in a conventional technique as described above, there is an issue of reduced design flexibility around the door opening. Alternatively, since the lower slide rail is disposed, there is an issue of reduced component mounting capability in a lower portion of the vehicle body. On the other hand, mere elimination of the upper slide rail and the lower slide rail makes it difficult for the vehicle body to properly receive force acting in a tilting direction of the door.

A need thus exists for a sliding door support structure, which is not susceptible to the drawback mentioned above.

### SUMMARY

According to one aspect of this disclosure, a sliding door support structure slidably supporting a door that can open and close a door opening of a vehicle body, the sliding door support structure including:

a first slide support mechanism including a first slide rail either above the door opening or below the door opening in a vehicle body and regulating an opening and closing path of the door while supporting the door with respect to a vehicle body through the first slide rail; and

a second slide support mechanism including a second slide rail and a third slide rail that are provided below an upper end of the door opening and above a lower end of the door opening in a vehicle body and regulating an opening and closing path of the door while supporting the door, in which

the second slide rail and the third slide rail are disposed apart from each other in a vertical direction, and

the second slide support mechanism regulates an opening and closing path of the door while receiving a weight of the door through the second slide rail and receives force acting in a tilting direction of the door through the second slide rail and the third slide rail is provided.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating a part of a vehicle including a sliding door support structure according to this example;

FIG. 2 is a perspective view of the sliding door support structure;

FIG. 3 is a perspective view viewed from the same direction as that in FIG. 2 and illustrates a first central guide unit and a second central guide unit along with a central hinge;

FIG. 4 is a perspective view of the sliding door support structure and illustrates a position of the central hinge when a door is in an open state;

FIG. 5 is a perspective view viewed from the same direction as that in FIG. 4 and illustrates the first central guide unit and the second central guide unit along with the central hinge;

FIG. 6 is a plan view illustrating the central hinge viewed from above when the door is in the open state;

FIG. 7 is a plan view illustrating a rail forming member viewed from above;

FIG. 8 is a cross-sectional view of the rail forming member in a main guide section, the view being taken along a section parallel to a Y-Z plane;

FIG. 9 is a cross-sectional view of the sliding door support structure when the door is in the open state, the view being taken along a section parallel to the Y-Z plane;

FIG. 10 is a side view schematically illustrating a part of a vehicle including a sliding door support structure according to Example 2; and

FIG. 11 is a perspective view of a sliding door support structure according to Example 3.

### DETAILED DESCRIPTION

Examples are described in detail below with reference to the attached drawings. Note that scales used in the drawings are strictly examples and are not limited thereto; and the shapes and the like in the drawings may be partially exaggerated for convenience of description. Further, only a part of a plurality of parts with the same attributes may be given reference signs in the drawings for better recognizability.

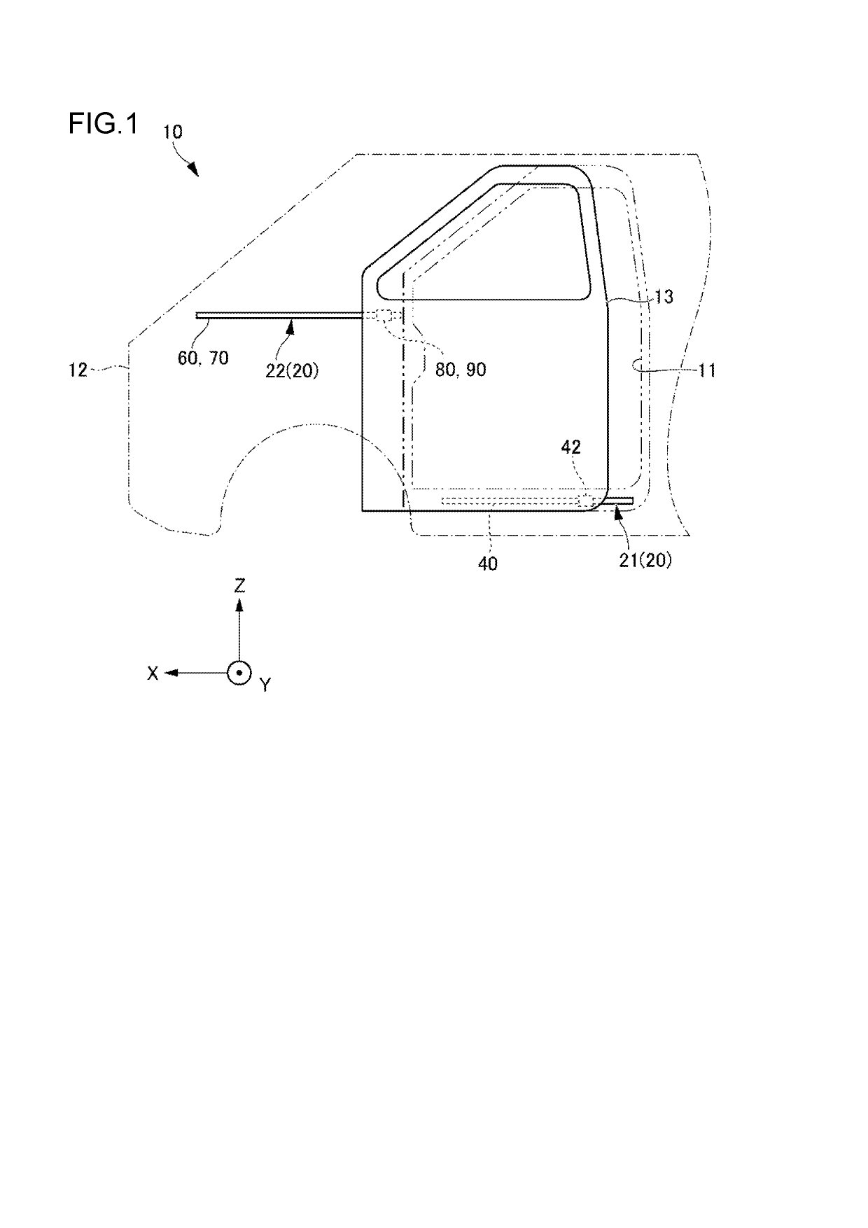

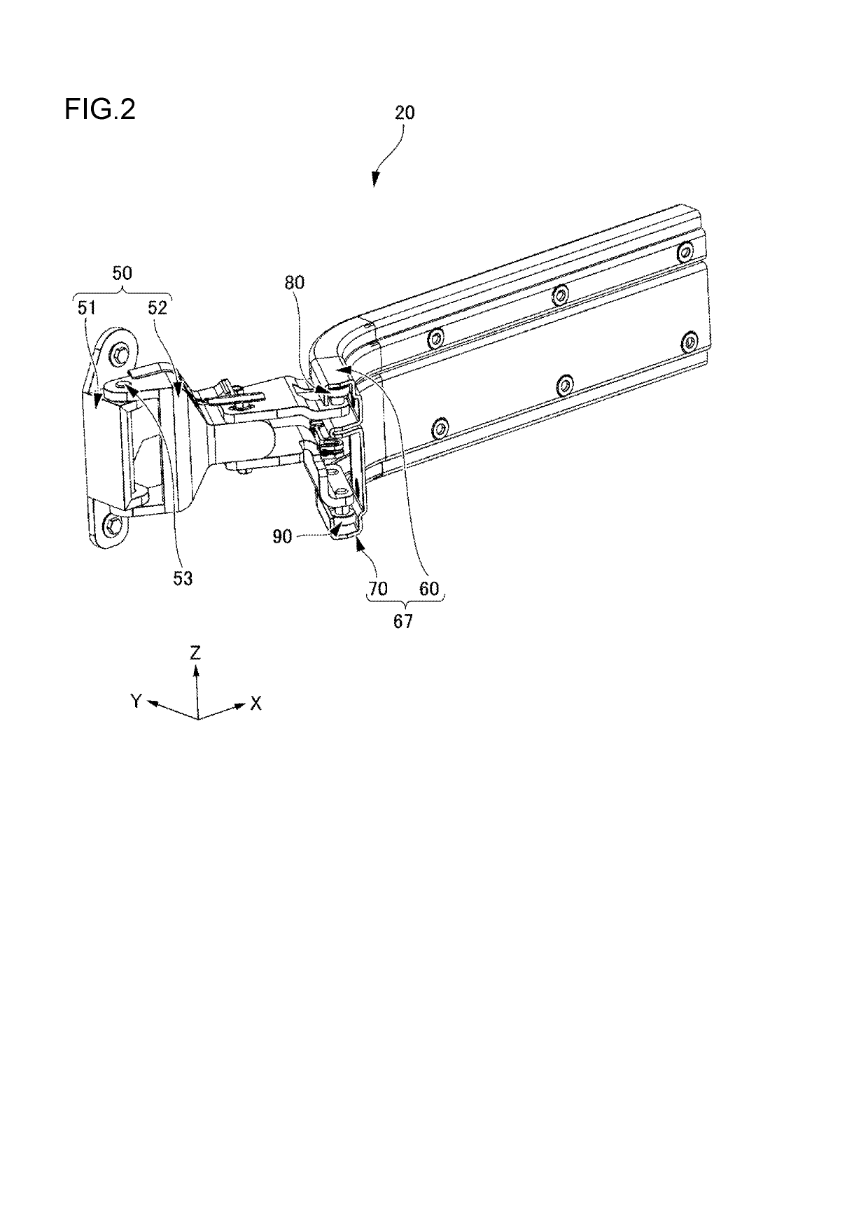

FIG. 1 is a side view schematically illustrating a part of a vehicle 10 including a sliding door support structure 20 according to this example. FIG. 1 illustrates three orthogonal axes (an X-axis, a Y-axis, and a Z-axis) in a right-handed coordinate system. In this example, the X direction corresponds to the longitudinal direction of the vehicle, and the positive X direction corresponds to the rear side. The Y direction corresponds to the vehicle width direction, and the positive Y direction corresponds to the outward side (the side away from the center of the vehicle body). The Z direction corresponds to the vertical direction, and the positive Z direction corresponds to the upward side. The same coordinate system is illustrated in FIG. 2 and subsequent diagrams in the same manner.

As illustrated in FIG. 1, the vehicle 10 includes a vehicle body 12 provided with a door opening 11 on the side, a door 13 for opening and closing the door opening 11, and the sliding door support structure 20 slidably supporting the door 13 on the vehicle body 12.

The door 13 performs an opening and closing operation between a fully closed position restricting boarding and alighting of occupants with respect to the vehicle 10 through the door opening 11 and a fully open position allowing boarding and alighting of occupants with respect to the vehicle 10 through the door opening 11. In the following description, the degree of opening of the door 13 is also referred to as an opening degree of the door 13. In other words, the opening degree of the door 13 is minimum at the fully closed position and maximum at the fully open position. In this embodiment, the door 13 may be a sliding door manually operated by a user of the vehicle 10 or may be an electric door.

In this example, the sliding door support structure 20 includes a first slide support mechanism 21 and a second slide support mechanism 22.

The first slide support mechanism 21 includes a lower slide rail 40 and a lower guide unit 42. The lower slide rail 40 may be disposed below the door opening 11 (for example, near the lower end). The lower guide unit 42 may be connected to a position near the front edge of the lower end of the door 13. The first slide support mechanism 21 regulates the opening and closing path of the door 13 while supporting the door 13 with respect to the vehicle body 12 through the lower slide rail 40 and the lower guide unit 42.

Note that the configuration of the first slide support mechanism 21 (the configuration of each of the lower slide rail 40 and the lower guide unit 42) is optional, and, for example, the configurations described in JP2018-80468A and JP2020-79513A that may be incorporated herein by reference may be employed.

The second slide support mechanism 22 includes a first central slide rail 60, a second central slide rail 70, a first central guide unit 80, and a second central guide unit 90.

Note that, for example, the first central slide rail 60 and the second central slide rail 70 may be disposed in a recessed portion formed as a depression on the vehicle body 12.

The first central slide rail 60 and the second central slide rail 70 are disposed below the upper end of the door opening 11 and above the lower end of the door opening 11. In this example, the first central slide rail 60 and the second central slide rail 70 are disposed behind the door opening 11. Note that the first central slide rail 60 and the second central slide rail 70 are positioned above the lower slide rail 40 in the vehicle.

The first central guide unit 80 is provided with respect to the first central slide rail 60. The second central guide unit 90 is provided with respect to the second central slide rail 70. The first central guide unit 80 and the second central guide unit 90 may be connected to a position at the center of the door 13 in the vertical direction of the vehicle and near the rear end of the door 13.

Note that while the door 13 is used for the rear seat in this example, the sliding door support structure 20 in this example is applicable to any door. Further, while the door 13 is a type sliding backward, the door may also be a type sliding forward.

Thus, since there is no sliding door support mechanism above the door opening 11 in this example, the design flexibility of the upper rear side of the vehicle body can be enhanced.

Next, the details of the second slide support mechanism 22 in the sliding door support structure 20 are described with reference to FIG. 2 and subsequent diagrams.

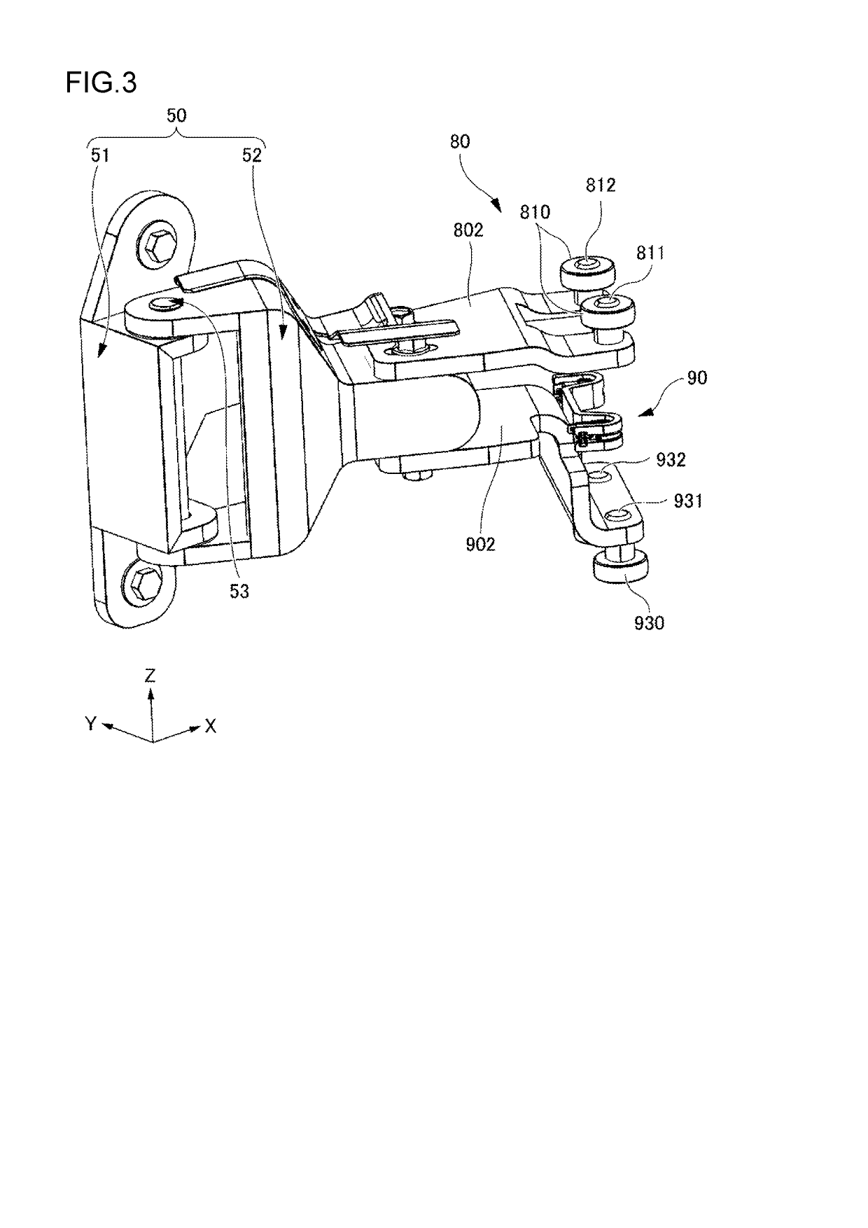

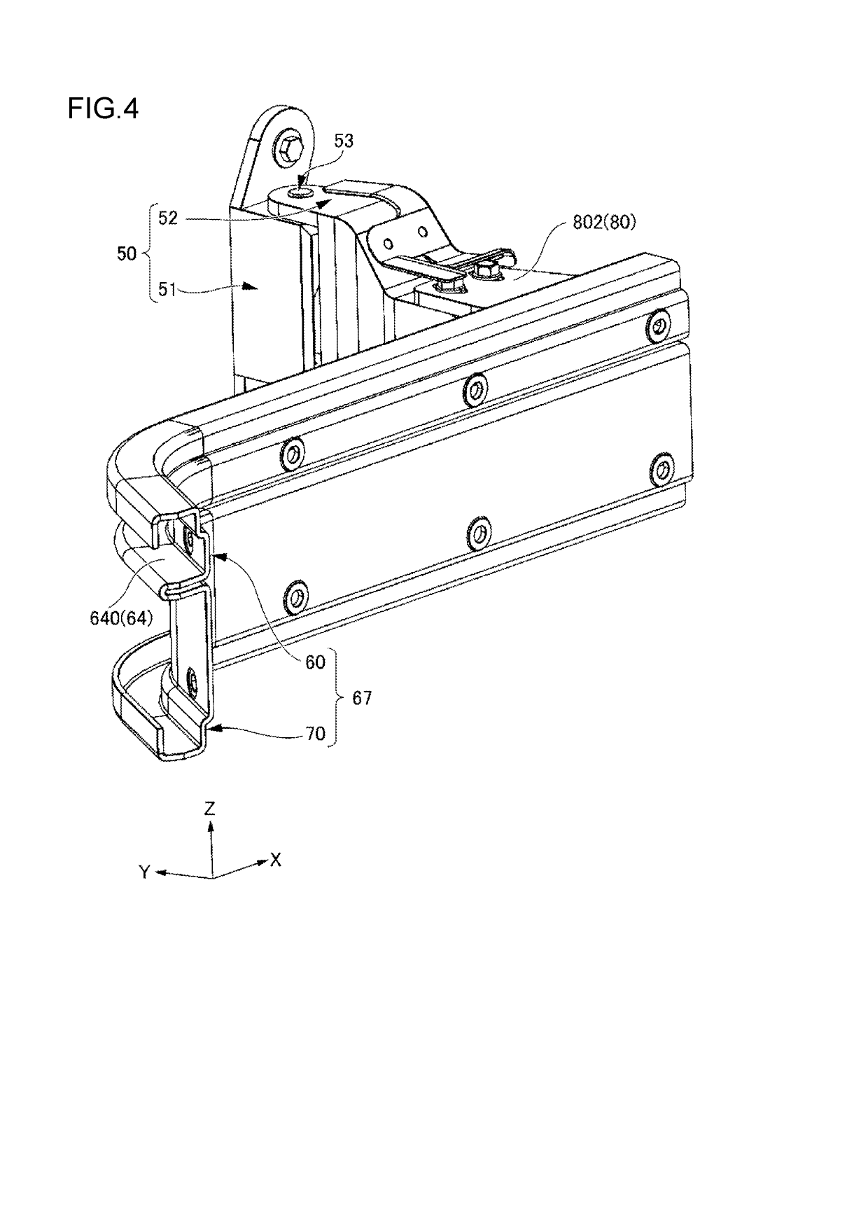

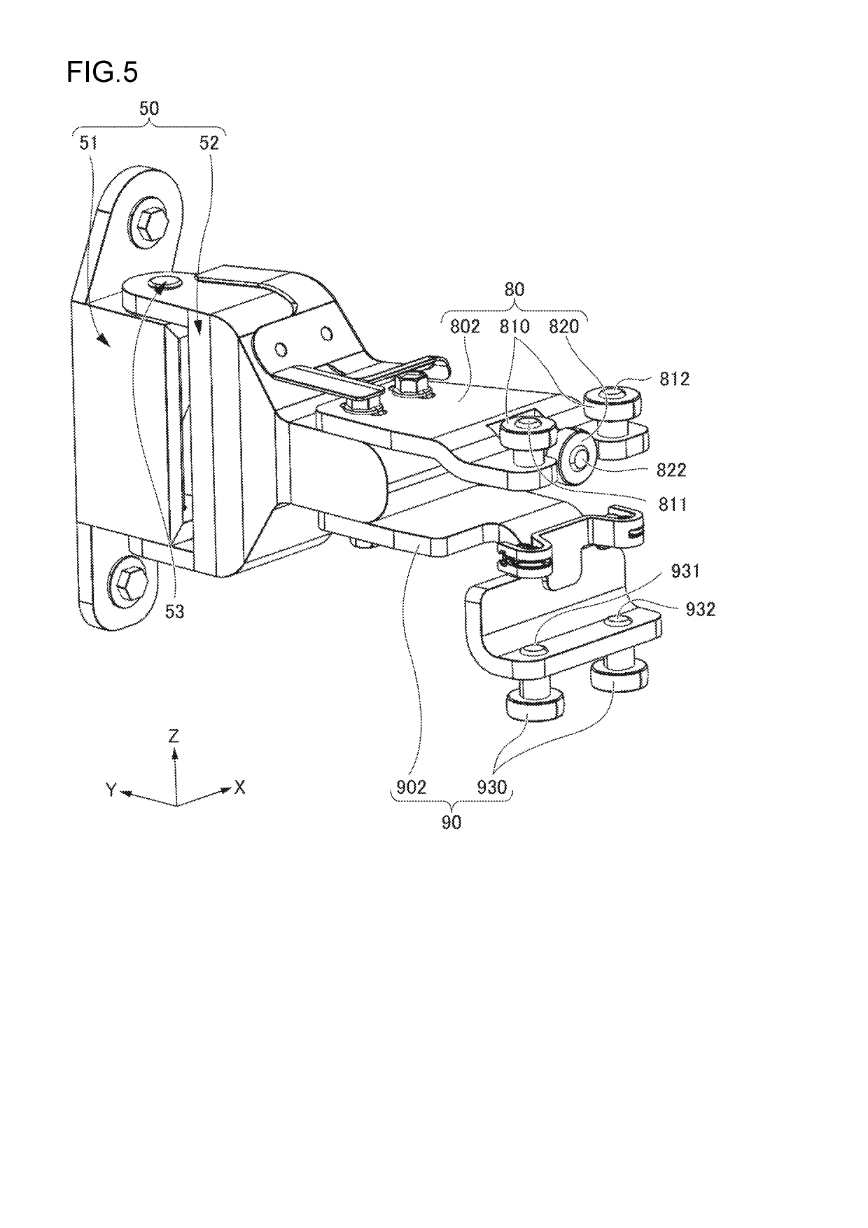

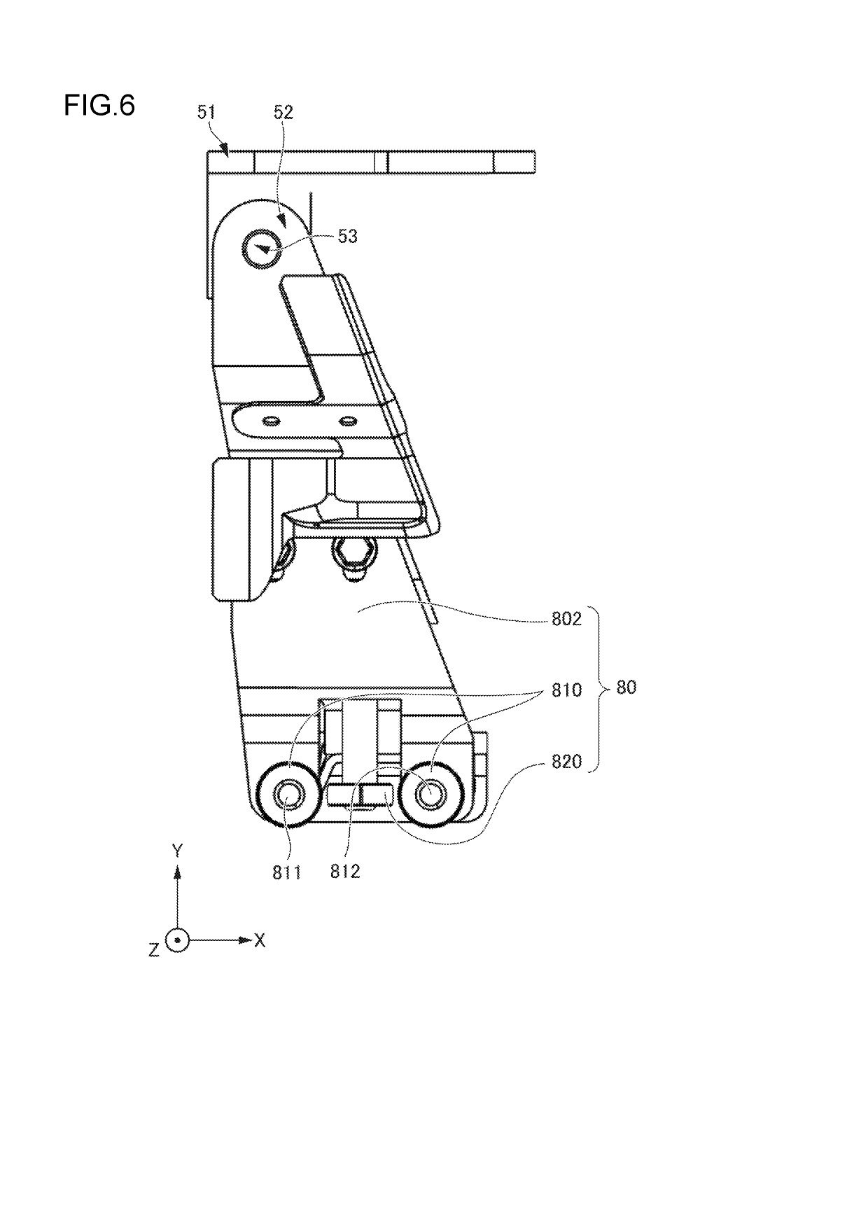

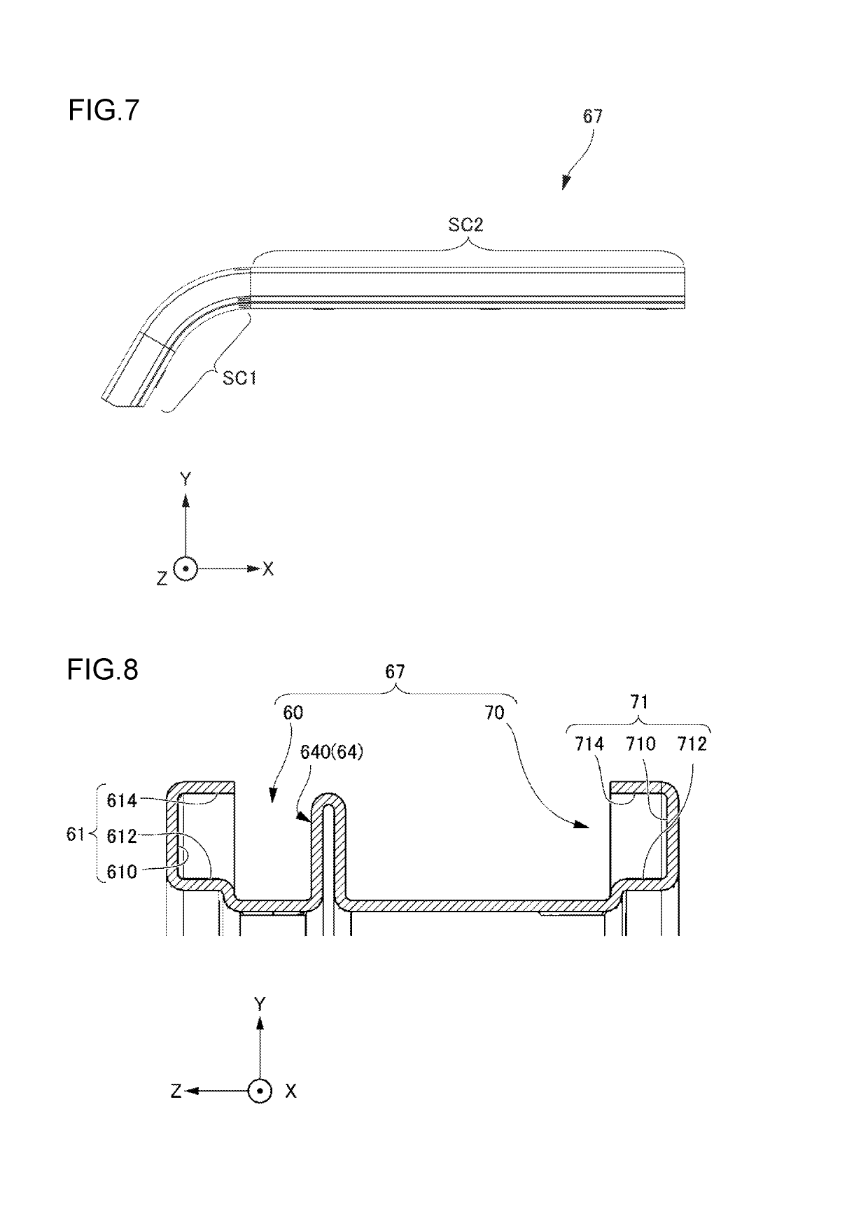

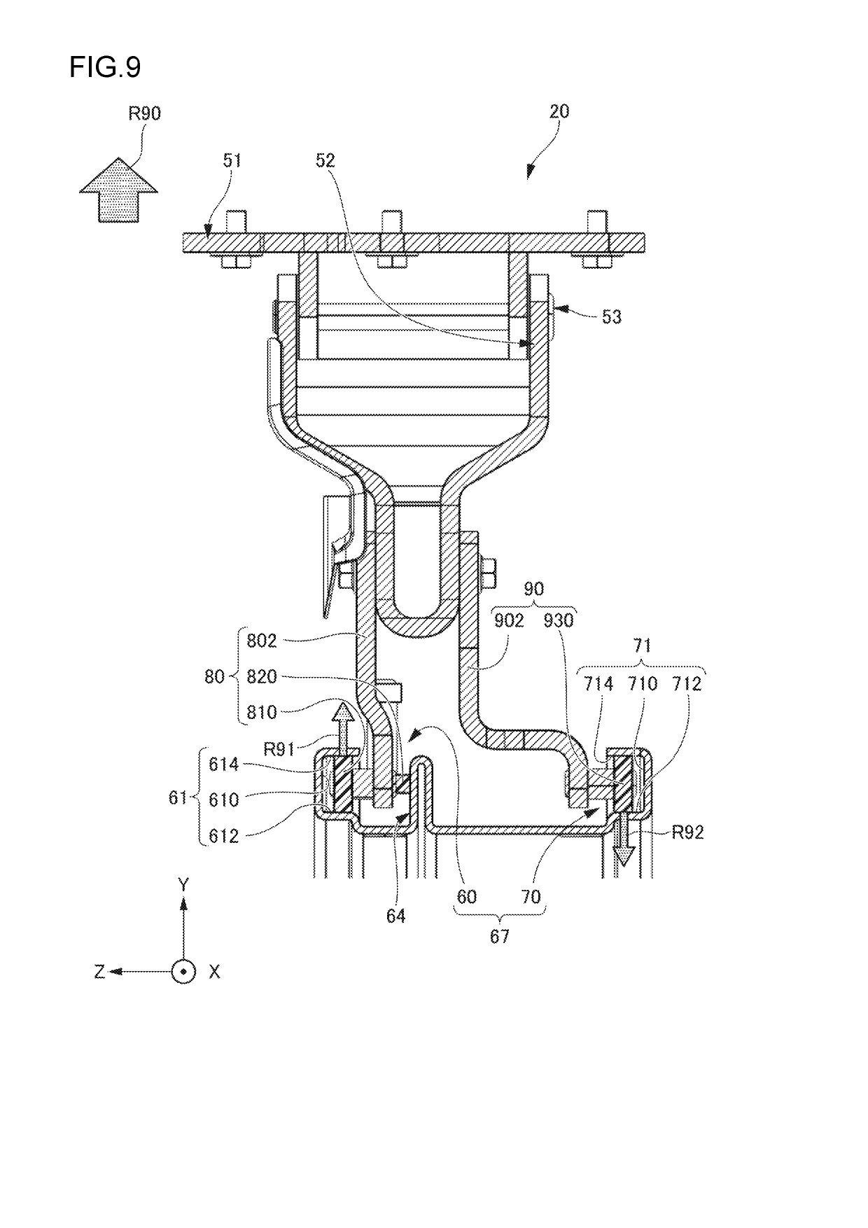

FIG. 2 is a perspective view of the sliding door support structure 20 and illustrates the position of a central hinge 50 when the door 13 (not illustrated in FIG. 2) is in the closed state. FIG. 3 is a perspective view viewed from the same direction as that in FIG. 2 and illustrates the first central guide unit 80 and the second central guide unit 90 along with the central hinge 50. FIG. 4 is a perspective view of the sliding door support structure 20 and illustrates the position of the central hinge 50 when the door 13 (not illustrated in FIG. 4) is in the open state. FIG. 5 is a perspective view viewed from the same direction as that in FIG. 4 and illustrates the first central guide unit 80 and the second central guide unit 90 along with the central hinge 50. FIG. 6 is a plan view viewed from above and illustrates the central hinge 50 when the door 13 (not illustrated in FIG. 6) is in the open state. FIG. 7 is a plan view of a rail forming member 67 viewed from above. FIG. 8 is a cross-sectional view of the rail forming member 67 in a main guide section SC2, the view being taken along a section parallel to the Y-Z plane. FIG. 9 is a cross-sectional view of the sliding door support structure 20 when the door 13 (not illustrated in FIG. 9) is in the open state, the view being taken along a section parallel to the Y-Z plane.

The first central slide rail 60 and the second central slide rail 70 are disposed apart from each other in the vertical direction. In this example, the first central slide rail 60 and the second central slide rail 70 are formed from a single common member (hereinafter also referred to as the “rail forming member 67”). The first central slide rail 60 and the second central slide rail 70 are formed in such a manner that the opening and closing paths (guide paths) related to the respective rails overlap when viewed in the vertical direction. In this case, the manufacturability of the rail forming member 67 is improved as a single member.

The first central slide rail 60 and the second central slide rail 70 may form an initial guide section SC1 moving the door 13 in the closed state outward in the vehicle width direction and the main guide section SC2 moving the door 13 toward the rear of the vehicle in the longitudinal direction of the vehicle (see FIG. 7). Note that the boundary between the initial guide section SC1 and the main guide section SC2 does not need to be strictly defined, and the sections may be continuous through a curved portion.

The first central slide rail 60 mainly has a function of regulating the opening and closing path of the door 13 while receiving the weight of the door 13 in cooperation with the first central guide unit 80 to be described later.

The second central slide rail 70 mainly has a function of receiving force in the tilting direction of the door 13 (the direction in which the upper portion tilts outward in the vehicle width direction) in cooperation with the second central guide unit 90 to be described later. The second central slide rail 70 may have a function of regulating the opening and closing path of the door 13 in cooperation with the second central guide unit 90 to be described later.

The first central guide unit 80 is coupled to the central hinge 50. The central hinge 50 includes a door-side hinge portion 51 fixed to the door 13 side and a vehicle-body-side hinge portion 52. The door-side hinge portion 51 and the vehicle-body-side hinge portion 52 are connected in such a manner as to be rotatable around a vertical rotation axis 53. Note that the door-side hinge portion 51 and the vehicle-body-side hinge portion 52 substantially have no degrees of freedom other than rotation around the rotation axis 53.

The first central guide unit 80 includes an upper roller holding member 802 coupled to the upper side of the vehicle-body-side hinge portion 52 (see FIG. 3). The upper roller holding member 802 rotatably holds each of a pair of upper rollers 810 and a main roller 820 (see FIG. 5). The pair of upper rollers 810 and the main roller 820 are movable along the first central slide rail 60 while rotating.

The pair of upper rollers 810 respectively include vertical rotation axes 811 and 812. The two rotation axes 811 and 812 may be disposed side by side in the longitudinal direction of the vehicle at the fully open position of the door 13. At this time, the two rotation axes 811 and 812 are preferably disposed in such a manner that a triangle formed by connecting the rotation axis 53 and the two rotation axes 811 and 812 is a right triangle, as can be seen in FIG. 6. In this case, at the fully open position of the door 13, a straight line connecting the rotation axis 811 on the front side of the vehicle out of the two rotation axes 811 and 812 and the rotation axis 53 may be almost parallel to the vehicle width direction when viewed from above. Such a disposition of the two rotation axes 811 and 53 allows force generated during the opening and closing operation of the door 13 to be efficiently transmitted to the vehicle body side. In other words, the force generated during the opening and closing operation of the door 13 mainly includes the directional component of a straight line connecting the rotation axis 811 on the front side of the vehicle and the rotation axis 53 viewed from above, and therefore, force with such a directional component can be efficiently transmitted to the vehicle body side.

The pair of upper rollers 810 is supported through an upper roller guide portion 61 of the first central slide rail 60. The upper roller guide portion 61 may include a C-shaped cross-sectional shape formed by an upper portion 610, a wall portion 612 on the inner side of the vehicle, and a wall portion 614 on the outer side of the vehicle and, in this case, partially surrounds the pair of upper rollers 810 from above (with the lower side being open). In this case, the pair of upper rollers 810 is sandwiched in the vehicle width direction between the wall portion 612 on the inner side of the vehicle and the wall portion 614 on the outer side of the vehicle. Consequently, force acting in the tilting direction of the door 13 can be received by the wall portion 614 on the outer side of the vehicle. When the door 13 begins to be displaced in the tilting direction, further displacement of the door 13 can be prevented by the pair of upper rollers 810 coming into contact with the wall portion 614 on the outer side of the vehicle and the force acting in the tilting direction of the door 13 being received at the wall portion 612 on the inner side of the vehicle (see an arrow R91 in FIG. 9). Note that when the door 13 begins to tilt (see an arrow R90 in FIG. 9), a moment in the tilting direction is generated around the contact point between the main roller 820 and a lower wall portion 640 to be described later (see FIG. 4).

The pair of upper rollers 810 is supported through the upper roller guide portion 61 of the first central slide rail 60. The upper roller guide portion 61 may include a C-shaped cross-sectional shape formed by the upper portion 610, the wall portion 612 on the inner side of the vehicle, and the wall portion 614 on the outer side of the vehicle and, in this case, partially surrounds the pair of upper rollers 810 from above (with the lower side being open). In this case, the pair of upper rollers 810 is sandwiched in the vehicle width direction between the wall portion 612 on the inner side of the vehicle and the wall portion 614 on the outer side of the vehicle. Consequently, the force acting in the tilting direction of the door 13 can be received by the wall portion 614 on the outer side of the vehicle. When the door 13 begins to be displaced in the tilting direction, further displacement of the door 13 can be prevented by the pair of upper rollers 810 coming into contact with the wall portion 614 on the outer side of the vehicle and the force acting in the tilting direction of the door 13 being received at the wall portion 612 on the inner side of the vehicle. Note that when the door 13 begins to tilt, force (moment) in the tilting direction is generated around the contact point between the main roller 820 and the lower wall portion 640 to be described later.

Further, during the opening and closing operation of the door 13, the opening and closing path of the door 13 can be regulated by the pair of upper rollers 810 coming into contact with the wall portion 612 on the inner side of the vehicle or the wall portion 614 on the outer side of the vehicle. Note that necessary clearances may be set in a direction within the horizontal plane (a direction perpendicular to the movement path) between the pair of upper rollers 810, and the wall portion 612 on the inner side of the vehicle and the wall portion 614 on the outer side of the vehicle. Further, a necessary clearance is set in the vertical direction between the pair of upper rollers 810 and the upper portion 610. Note that the upper portion 610 of the upper roller guide portion 61 may be omitted in part or in whole in a modified example.

The main roller 820 includes a rotation axis 822 in the horizontal plane. The rotation axis 822 may be almost parallel to the vehicle width direction at the fully open position of the door 13 when viewed from above. The rotation axis 822 may be provided below the pair of upper rollers 810 and above a pair of lower rollers 930 to be described later. The main roller 820 is supported through a main roller guide portion 64 of the first central slide rail 60. The main roller guide portion 64 includes a lower wall portion 640 supporting the main roller 820 from below. Consequently, the first central guide unit 80 can receive the weight of the door 13 through the main roller 820 and the main roller guide portion 64. Note that the main roller 820 may be positioned between the pair of upper rollers 810 in the longitudinal direction when viewed from above at the fully open position of the door 13.

The second central guide unit 90 is coupled to the central hinge 50. In other words, the second central guide unit 90 is coupled to the central hinge 50 along with the first central guide unit 80. In this case, the central hinge 50 is shared, which can reduce the number of components.

The second central guide unit 90 is disposed below the first central slide rail 60. Specifically, the second central guide unit 90 includes a lower roller holding member 902 coupled to the lower side of the vehicle-body-side hinge portion 52. The lower roller holding member 902 rotatably holds the pair of lower rollers 930. The pair of lower rollers 930 is movable along the second central slide rail 70 while rotating.

The pair of lower rollers 930 respectively include vertical rotation axes 931 and 932. The two rotation axes 931 and 932 may be disposed side by side in the longitudinal direction of the vehicle at the fully open position of the door 13. The two rotation axes 931 and 932 are preferably coaxial with the two rotation axes 811 and 812 of the upper rollers 810 described above, respectively. In this case, each of the first central slide rail 60 and the second central slide rail 70 can be formed in such a manner that the rails substantially overlap when viewed from above. Consequently, when the first central slide rail 60 and the second central slide rail 70 are formed from a single common member, the manufacturability of the single common member can be improved. Further, the disposition of such two rotation axes 931 and 932 allows the force generated during the opening and closing operation of the door 13 to be efficiently transmitted to the vehicle body side. In other words, the force generated during the opening and closing operation of the door 13 mainly includes the directional component of a straight line connecting the rotation axis 931 on the front side of the vehicle and the rotation axis 53 when viewed from above, and therefore, force with such a directional component can be efficiently transmitted to the vehicle body side.

The pair of lower rollers 930 is supported through the lower roller guide portion 71 of the second central slide rail 70. The lower roller guide portion 71 includes a C-shaped cross-sectional shape formed by the lower wall portion 710, the wall portion 712 on the inner side of the vehicle, and the wall portion 714 on the outer side of the vehicle and, in this case, partially surrounds the pair of lower rollers 930 from below (with the upper side being open). At this time, the pair of lower rollers 930 is sandwiched in the vehicle width direction between the wall portion 712 on the inner side of the vehicle and the wall portion 714 on the outer side of the vehicle. Consequently, the force acting in the tilting direction of the door 13 can be received by the wall portion 712 on the inner side of the vehicle (see an arrow R92 in FIG. 9). In other words, when the door 13 begins to be displaced in the tilting direction, further displacement of the door 13 can be prevented by the pair of lower rollers 930 coming into contact with the wall portion 712 on the inner side of the vehicle and the force acting in the tilting direction of the door 13 being received at the wall portion 712 on the inner side of the vehicle.

Further, during the opening and closing operation of the door 13, the opening and closing path of the door 13 can be regulated by the pair of lower rollers 930 coming into contact with the wall portion 712 on the inner side of the vehicle or the wall portion 714 on the outer side of the vehicle. Note that necessary clearances may be set in a direction within the horizontal plane (a direction perpendicular to the movement path) between the pair of lower rollers 930, and the wall portion 712 on the inner side of the vehicle and the wall portion 714 on the outer side of the vehicle.

Note that while the lower roller guide portion 71 includes a C-shaped cross-sectional shape formed by the lower wall portion 710, the wall portion 712 on the inner side of the vehicle, and the wall portion 714 on the outer side of the vehicle in this example, the wall portion 714 on the outer side of the vehicle may be omitted. In this case, during the opening and closing operation of the door 13, the pair of lower rollers 930 no longer comes into contact with the wall portion 714 on the outer side of the vehicle; and in this respect, the regulating function related to the opening and closing path of the door 13 is degraded. However, since such a regulating function is ensured by the pair of upper rollers 810 and the upper roller guide portion 61, no particular issue arises. Further, the lower wall portion 710 may also be omitted when the wall portion 714 on the outer side of the vehicle is omitted (or when the wall portion 714 on the outer side of the vehicle is not omitted),.

While the pair of lower rollers 930 are provided in this example, one of the pair of lower rollers 930 may be omitted. In this case, the roller including the rotation axis 931 out of the pair of lower rollers 930 is preferably retained. In this case, the force generated during the opening and closing operation of the door 13 can be efficiently transmitted to the vehicle body side. In other words, the force generated during the opening and closing operation of door 13 mainly includes the directional component of the straight line connecting the rotation axis 931 and the rotation axis 53 of the central hinge 50 when viewed from above, and therefore, force with such a directional component can be efficiently transmitted to the vehicle body side. Further, when one of the pair of lower rollers 930 is omitted, the wall portion 714 on the outer side of the vehicle is preferably retained without being omitted from the lower roller guide portion 71. The reason is that, when only one of the pair of lower rollers 930 is present, the function of regulating rotation of the door 13 around the rotation axis 53 of the central hinge 50 is degraded. In other words, the function of regulating rotation of the door 13 around the rotation axis 53 of the central hinge 50 can be improved by the lower roller 930 coming into contact with the wall portion 714 on the outer of the vehicle.

When a sliding door support mechanism section (for example, an upper slide rail) that may be provided above the door opening 11 is eliminated as is the case in this example, the force acting in the tilting direction of the door 13 can no longer be received by such a sliding door support mechanism section above the door opening 11. In other words, the upper side of the door 13 cannot generate force properly counteracting tilting of the door 13 toward the outside of the vehicle.

On the other hand, according to this example, the force acting in the tilting direction of the door 13 can be properly received by providing the second slide support mechanism 22, as described above. In other words, according to this example, the upper slide rail and the like can be eliminated while properly receiving the force acting in the tilting direction of the door 13. Consequently, the design flexibility of the upper rear portion around the door opening 11 can be enhanced.

Next, other examples that may be provided in place of the example described above are described. In the following description, the example described above is also referred to as “Example 1,” and the other examples described below are referred to as “Example 2” and “Example 3” for the sake of distinction. In the following descriptions of Example 2 and Example 3, components that may be the same as those in Example 1 described above may be given the same reference signs, and description thereof may be omitted.

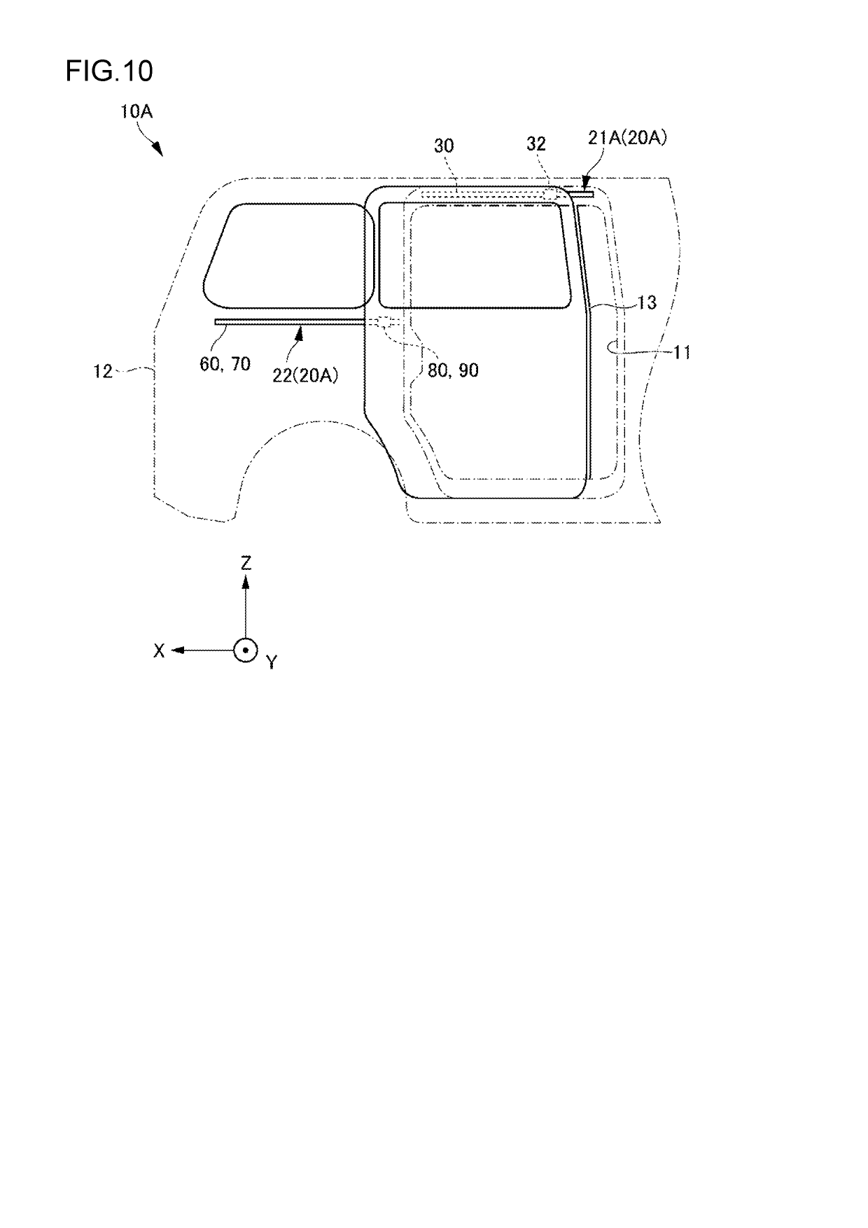

FIG. 10 is a side view schematically illustrating a part of a vehicle 10A including a sliding door support structure 20A according to Example 2.

While a sliding door support mechanism section that may be provided above the door opening 11 (for example, an upper slide rail) is eliminated in Example 1 described above, a sliding door support mechanism section that may be provided below the door opening 11 (for example, a lower slide rail) is eliminated instead in Example 2.

Specifically, the sliding door support structure 20A includes a first slide support mechanism 21A and a second slide support mechanism 22 in this example.

The first slide support mechanism 21A includes an upper slide rail 30 and an upper guide unit 32. The upper slide rail 30 may be disposed above a door opening 11 (for example, near the upper end of the door opening 11). The upper guide unit 32 may be connected to a position near the front edge of a door 13. The first slide support mechanism 21A regulates an opening and closing path of the door 13 while supporting the door 13 with respect to a vehicle body 12 through the upper slide rail 30 and the upper guide unit 32.

Note that the configuration of the first slide support mechanism 21A (the configuration of each of the upper slide rail 30 and the upper guide unit 32) is optional, and, for example, the configurations described in JP2018-80468A and JP2020-79513A that may be incorporated herein by reference may be employed.

When a sliding door support mechanism section (for example, a lower slide rail) that may be provided below the door opening 11 is eliminated as is the case in this example, force acting in the tilting direction of the door 13 can no longer be received by such a sliding door support mechanism section below the door opening 11. In other words, the lower side of the door 13 cannot generate force properly counteracting tilting of the door 13 toward the inside of the vehicle.

On the other hand, according to this example, force acting in the tilting direction of the door 13 can be properly received by providing the second slide support mechanism 22, as described above. In other words, according to this example, a lower slide rail and the like can be eliminated while properly receiving the force acting in the tilting direction of the door 13. Consequently, the component mounting capability in the lower portion of the vehicle body below the door opening 11 can be improved. For example, a battery frame can be disposed by utilizing the space in which the lower slide rail is disposed, which can improve the capability for mounting a high-voltage battery pack for an electric vehicle and a hybrid vehicle.

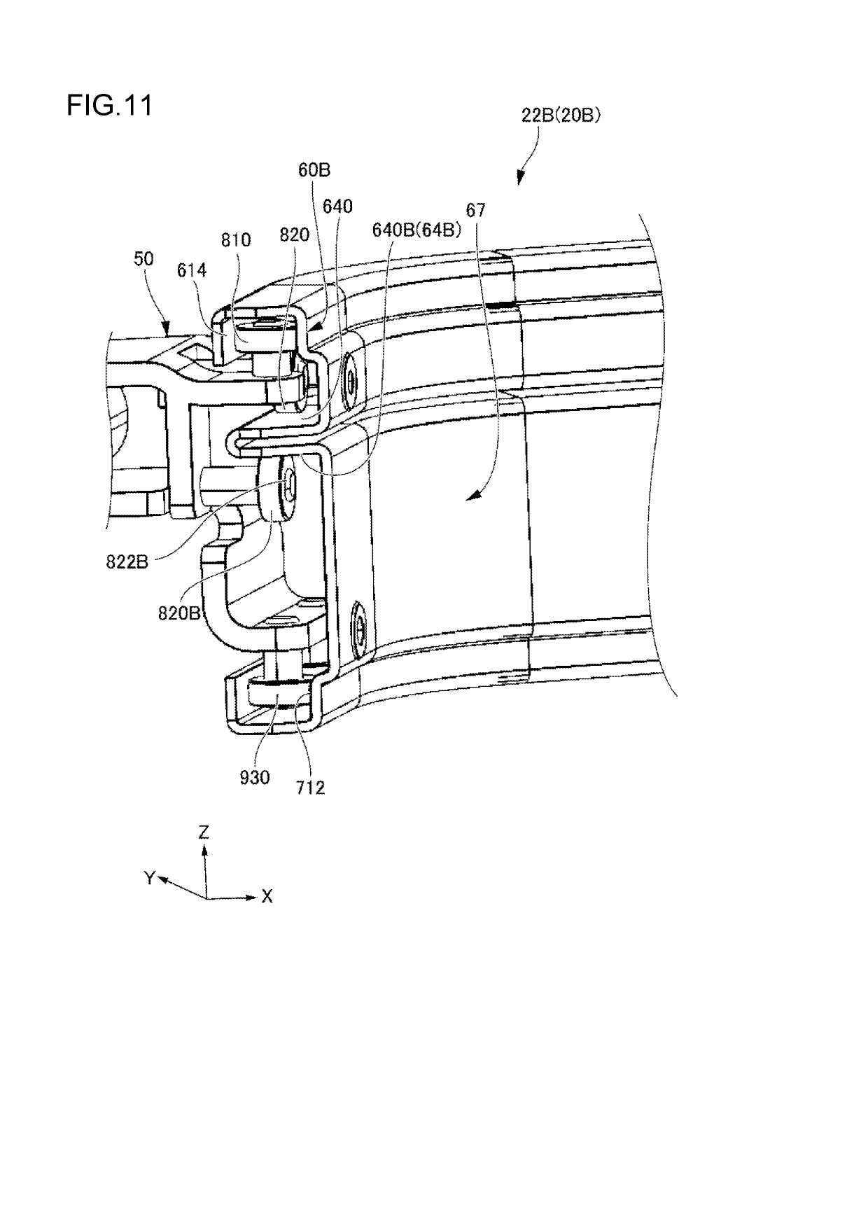

FIG. 11 is a perspective view of a sliding door support structure 20B according to Example 3.

The sliding door support structure 20B according to Example 3 differs from the sliding door support structure 20 according to Example 1 described above in that the second slide support mechanism 22 is replaced with a second slide support mechanism 22B.

The second slide support mechanism 22B according to Example 3 differs from the second slide support mechanism 22 according to Example 1 described above in that a second main roller 820B is added.

The second main roller 820B is positioned on the front side (and on the inner side) of the vehicle with respect to the main roller 820 when a door 13 is at a fully closed position. The second main roller 820B includes a rotation axis 822B within the horizontal plane. Note that the rotation axis 822B may be almost parallel to the vehicle width direction at a fully open position of the door 13 when viewed from above. The rotation axis 822B may be provided below a pair of upper rollers 810 and above a pair of lower rollers 930. The second main roller 820B is supported through a second main roller guide portion 64B of a first central slide rail 60B. The second main roller guide portion 64B includes an upper wall portion 640B facing the second main roller 820B from above in the vertical direction. Consequently, the first central slide rail 60B can receive force acting in the tilting direction of the door 13 through the second main roller 820B and the second main roller guide portion 64B.

Specifically, when the door 13 begins to be displaced in the tilting direction at the fully closed position of the door 13, further displacement of the door 13 can be prevented by the second main roller 820B coming into contact with the upper wall portion 640B of the second main roller guide portion 64B and the force acting in the tilting direction of the door 13 being received at the upper wall portion 640B. Note that when the door 13 begins to tilt, a moment in the tilting direction is generated around the contact point between the main roller 820 and a lower wall portion 640. Since the second main roller 820B is positioned on the inner side of the vehicle with respect to the main roller 820 at the fully closed position of the door 13, a moment counteracting the moment in the tilting direction can be efficiently generated by upward force acting on the upper wall portion 640B from the second main roller 820B.

Note that while the aspect of the second main roller 820B having the function of receiving the force acting in the tilting direction of the door 13 at the fully closed position of the door 13 has been described, such a function is achieved not only at the fully closed position of the door 13 but is also achieved near the fully closed position of the door 13 (mainly in an initial guide section SC1). In other words, when the door 13 begins to be displaced in the tilting direction (when the upper portion of the door 13 begins to be displaced toward the outside of the vehicle) in the initial guide section SC1, a moment is generated in a direction in which the second main roller 820B comes into contact with the upper wall portion 640B of the second main roller guide portion 64B.

Note that, in Example 3, when the door 13 begins to be displaced in the tilting direction (when the upper portion of the door 13 begins to be displaced toward the outside of the vehicle) in a main guide section SC2, further displacement of the door 13 can be prevented by the pair of upper rollers 810 coming into contact with a wall portion 614 on the outer side of the vehicle and the force acting in the tilting direction of the door 13 being received by a wall portion 612 on the inner side of the vehicle, and the pair of lower rollers 930 coming into contact with a wall portion 712 on the inner side of the vehicle and the force acting in the tilting direction of the door 13 being received by the wall portion 612 on the inner side of the vehicle, as described in Example 1.

Thus, in Example 3, the second main roller 820B and the upper wall portion 640B are mainly responsible for the function of receiving the force acting in the tilting direction in the initial guide section SC1, and the pair of lower rollers 930 and the wall portion 712 on the inner side of the vehicle are mainly responsible for the function of receiving the force acting in the tilting direction in the main guide section SC2.

While the examples have been described above, this disclosure is not limited to specific examples, and various modifications and changes may be made within the scope described in the claims. Further, all or some of the components of the examples described above may also be combined.

For example, in Example 1 described above (and Examples 2 and 3 as well, the same applies below), the second central slide rail 70 and the second central guide unit 90 are disposed below the first central slide rail 60 and the first central guide unit 80 in the sliding door support structure 20 but may be disposed in a reverse manner. In other words, the second central slide rail 70 and the second central guide unit 90 may be disposed above the first central slide rail 60 and the first central guide unit 80.

Further, the main roller 820 is held by the upper roller holding member 802 in Example 1 described above but may be held by the lower roller holding member 902 in a modified example. In this case, the main roller 820 moves along the lower wall portion 710 while rotating, and the lower wall portion 710 receives the weight of the door 13 from the main roller 820. Further, the upper roller holding member 802 and/or the lower roller holding member 902 may be a member integrated with the vehicle-body-side hinge portion 52.

Further, in Example 1 described above, the first central slide rail 60 and the second central slide rail 70 are formed from a single common member (the rail forming member 67) but are not limited thereto. For example, the first central slide rail 60 and the second central slide rail 70 may be formed from separate members.

With regard to the examples described above, the following supplementary notes are further disclosed.

### Supplementary Note 1

A sliding door support structure slidably supporting a door that can open and close a door opening of a vehicle body, the sliding door support structure including:

a first slide support mechanism including a first slide rail either above the door opening or below the door opening in a vehicle body and regulating an opening and closing path of the door while supporting the door with respect to a vehicle body through the first slide rail; and

a second slide support mechanism including a second slide rail and a third slide rail that are provided below an upper end of the door opening and above a lower end of the door opening in a vehicle body and regulating an opening and closing path of the door while supporting the door, wherein

the second slide rail and the third slide rail are disposed apart from each other in a vertical direction, and

the second slide support mechanism regulates an opening and closing path of the door while receiving a weight of the door through the second slide rail and receives force acting in a tilting direction of the door through the second slide rail and the third slide rail.

### Supplementary Note 2

The sliding door support structure according to Supplementary Note 1, wherein the second slide rail and the third slide rail overlap when viewed in a vertical direction.

### Supplementary Note 3

The sliding door support structure according to Supplementary Note 1, wherein

the second slide support mechanism further includes a first roller moving along a first wall portion provided on either one of the second slide rail and the third slide rail while rotating, a second roller moving along the second slide rail while rotating, and a third roller moving along the third slide rail while rotating,

the first wall portion receives a weight of the door from the first roller,

the second slide rail includes a second wall portion on an outer side of a vehicle, the second wall portion receiving force acting in a tilting direction of the door from the second roller, and

the third slide rail includes a third wall portion on an inner side of a vehicle, the third wall portion receiving force acting in a tilting direction of the door from the third roller.

### Supplementary Note 4

The sliding door support structure according to Supplementary Note 3, wherein the second slide support mechanism further includes a fourth roller and a fourth wall portion receiving force acting in a tilting direction of the door from the fourth roller, the fourth wall portion facing the fourth roller in a vertical direction.

### Supplementary Note 5

The sliding door support structure according to Supplementary Note 4, wherein

the second slide support mechanism includes a first roller and a first wall portion receiving a weight of the door from the first roller, the first wall portion facing the first roller in a vertical direction, and

the fourth roller is disposed on a front side of a vehicle with respect to the first roller.

### Supplementary Note 6

The sliding door support structure according to any one of Supplementary Notes 1, 2, 4, and 5, wherein

the second slide support mechanism further includes two second rollers that move along the second slide rail while rotating and two third rollers that move along the third slide rail while rotating,

the second slide rail sandwiches the two second rollers between a wall portion on an inner side of a vehicle and a wall portion on an outer side of a vehicle, and

the third slide rail includes an L-shaped cross section formed by a lower portion and a wall portion on an inner side of a vehicle, the cross section partially surrounding the two third rollers.

### Supplementary Note 7

The sliding door support structure according to any one of Supplementary Notes 1, 2, 4, and 6, wherein

the second slide support mechanism further includes two second rollers moving along the second slide rail while rotating and one third roller moving along the third slide rail while rotating,

the second slide rail sandwiches the two second rollers between a wall portion on an inner side of a vehicle and a wall portion on an outer side of a vehicle, and

the third slide rail sandwiches the one third roller between a wall portion on an inner side of a vehicle and a wall portion on an outer side of a vehicle.

### Supplementary Note 8

The sliding door support structure according to Supplementary Note 6 or 7, wherein

the second slide support mechanism further includes a support member rotatably supporting the two second rollers, and the support member is rotatably supported around a first rotation axis with respect to the door, and,

when viewed in a vertical direction, a triangle formed by connecting each of second rotation axes of the two second rollers and the first rotation axis constitutes a right triangle at a fully open position of the door.

### Supplementary Note 9

The sliding door support structure according to Supplementary Note 7, wherein

the second slide support mechanism further includes a support member rotatably supporting the two second rollers, and the support member is rotatably supported around a first rotation axis with respect to the door,

when viewed in a vertical direction, a triangle formed by connecting each of second rotation axes of the two second rollers and the first rotation axis constitutes a right triangle at a fully open position of the door, and

a third rotation axis of the third roller is coaxial with the second rotation axis of one of the two second rollers and, when viewed in a vertical direction, a triangle formed by connecting the second rotation axis of another of the two second rollers and the first rotation axis constitutes a right triangle at a fully open position of the door.

According to one aspect of this disclosure, a sliding door support structure slidably supporting a door that can open and close a door opening of a vehicle body, the sliding door support structure including:

a first slide support mechanism including a first slide rail either above the door opening or below the door opening in a vehicle body and regulating an opening and closing path of the door while supporting the door with respect to a vehicle body through the first slide rail; and

a second slide support mechanism including a second slide rail and a third slide rail that are provided below an upper end of the door opening and above a lower end of the door opening in a vehicle body and regulating an opening and closing path of the door while supporting the door, in which

the second slide rail and the third slide rail are disposed apart from each other in a vertical direction, and

the second slide support mechanism regulates an opening and closing path of the door while receiving a weight of the door through the second slide rail and receives force acting in a tilting direction of the door through the second slide rail and the third slide rail is provided.

According to the one aspect of this disclosure, elimination of the upper slide rail or the lower slide rail in the sliding door support structure can be achieved while properly receiving force acting in the tilting direction of the door.

In the sliding door support structure, the second slide rail and the third slide rail may overlap when viewed in a vertical direction.

In the sliding door support structure, the second slide support mechanism may further include a first roller moving along a first wall portion provided on the second slide rail while rotating, a second roller moving along the second slide rail while rotating, and a third roller moving along the third slide rail while rotating, the first wall portion may receive a weight of the door from the first roller, the second slide rail may include a second wall portion on an outer side of a vehicle, the second wall portion receiving force acting in a tilting direction of the door from the second roller, and the third slide rail may include a third wall portion on an inner side of a vehicle, the third wall portion receiving force acting in a tilting direction of the door from the third roller.

In the sliding door support structure, the second slide support mechanism may further include a fourth roller and a fourth wall portion receiving force acting in a tilting direction of the door from the fourth roller, the fourth wall portion facing the fourth roller in a vertical direction.

In the sliding door support structure, the door may include a window frame, and the second slide rail and the third slide rail may be provided below the window frame in a vertical direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A sliding door support structure slidably supporting a door that can open and close a door opening of a vehicle body, the sliding door support structure comprising:
a first slide support mechanism including a first slide rail either above the door opening or below the door opening in a vehicle body and regulating an opening and closing path of the door while supporting the door with respect to a vehicle body through the first slide rail; and
a second slide support mechanism including a second slide rail and a third slide rail that are provided below an upper end of the door opening and above a lower end of the door opening in a vehicle body and regulating an opening and closing path of the door while supporting the door, wherein
the second slide rail and the third slide rail are disposed apart from each other in a vertical direction, and
the second slide support mechanism regulates an opening and closing path of the door while receiving a weight of the door through the second slide rail and receives force acting in a tilting direction of the door through the second slide rail and the third slide rail.

2. The sliding door support structure according to claim 1, wherein the second slide rail and the third slide rail overlap when viewed in a vertical direction.

3. The sliding door support structure according to claim 1, wherein
the second slide support mechanism further includes a first roller moving along a first wall portion provided on the second slide rail while rotating, a second roller moving along the second slide rail while rotating, and a third roller moving along the third slide rail while rotating,
the first wall portion receives a weight of the door from the first roller,
the second slide rail includes a second wall portion on an outer side of a vehicle, the second wall portion receiving force acting in a tilting direction of the door from the second roller, and
the third slide rail includes a third wall portion on an inner side of a vehicle, the third wall portion receiving force acting in a tilting direction of the door from the third roller.

4. The sliding door support structure according to claim 3, wherein the second slide support mechanism further includes a fourth roller and a fourth wall portion receiving force acting in a tilting direction of the door from the fourth roller, the fourth wall portion facing the fourth roller in a vertical direction.

5. The sliding door support structure according to claim 1, wherein
the door includes a window frame, and
the second slide rail and the third slide rail are provided below the window frame in a vertical direction.

6. The sliding door support structure according to claim 2, wherein
the door includes a window frame, and
the second slide rail and the third slide rail are provided below the window frame in a vertical direction.

7. The sliding door support structure according to claim 3, wherein
the door includes a window frame, and
the second slide rail and the third slide rail are provided below the window frame in a vertical direction.

8. The sliding door support structure according to claim 4, wherein
the door includes a window frame, and
the second slide rail and the third slide rail are provided below the window frame in a vertical direction.
